(19) United States
(12) Patent Application Publication
(10) Pub. No.: US 2025/0150884 A1
(43) Pub. Date: May 8, 2025

(54) SYSTEMS AND METHODS FOR WIRELESS COMMUNICATION DEVICE DETECTION

(71) Applicant: ZTE CORPORATION, Shenzhen (CN)

(72) Inventors: Shuang ZHENG, Shenzhen (CN); Nan ZHANG, Shenzhen (CN); Ziyang LI, Shenzhen (CN); Wei CAO, Shenzhen (CN)

(73) Assignee: ZTE CORPORATION, Shenzhen (CN)

(21) Appl. No.: 19/017,707

(22) Filed: Jan. 12, 2025

Related U.S. Application Data
(63) Continuation of application No. PCT/CN2023/090327, filed on Apr. 24, 2023.

(51) Int. Cl. H04W 24/10; H04L 5/00; H04W 72/04; H04W 72/20; H04W 74/0833

(52) U.S. Cl. CPC H04W 24/10; H04L 5/0051; H04W 72/04; H04W 72/20; H04W 74/0833

(57) ABSTRACT

Presented are systems and methods for wireless communication device detection. A network node can measure a signal transmitted from a wireless communication device based on one or more configurations indicated by a wireless communication node.

### CROSS-REFERENCE TO RELATED APPLICATION

This application claims the benefit of priority under 35 U.S.C. § 120 as a continuation of PCT Patent Application No. PCT/CN2023/090327, filed on Apr. 24, 2023, the disclosure of which is incorporated herein by reference in its entirety.

### TECHNICAL FIELD

The disclosure relates generally to wireless communications, including but not limited to systems and methods for wireless communication device detection.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can measure a signal transmitted/sent/provided/communicated/propagated from a wireless communication device (e.g., UE) based on one or more configurations indicated by a wireless communication node (e.g., base station (BS), gNB, or transmission and reception point (TRP)).

In some implementations, the signal transmitted from the wireless communication device can include/comprise at least one of: a reference signal (RS), a RS with a dedicated port index used for UE detection, a RS with a dedicated RS index used for UE detection, wherein the reference signal comprises at least one of: a sounding reference signal (SRS), a demodulation reference signal (DM-RS), or a phase tracking reference signal (PT-RS), a preamble used for random access, a dedicated preamble used for UE detection, a dedicated sequence used for UE detection, a dedicated physical uplink control channel (PUCCH) transmission used for UE detection, a dedicated physical uplink shared channel (PUSCH) transmission used for UE detection, a PUCCH signal, and/or a PUSCH signal.

In some implementations, the dedicated preamble may be transmitted from the wireless communication device in a dedicated resource. The dedicated resource can include at least one of: a time domain resource, a frequency resource, or a dedicated preamble index. In some implementations, the dedicated sequence can include at least one of: an on-off keying (OOK) sequence, a Zadoff-Chu (ZC) sequence, a pseudo-random sequence, a computer-generated sequence (CGS), and/or a low peak-to-average-power ratio (PAPR) sequence.

In some implementations, when the signal is the preamble used for the random access, transmitted from the wireless communication device, the network node can measure the preamble during a random access channel (RACH) occasion.

In some implementations, the one or more configurations may be indicated to the network node via at least one of: a system information (SI) signal, a radio resource control (RRC) signal, a downlink control information (DCI) signal, and/or a medium access control element (MAC CE) signal. In some implementations, the one or more configurations can comprise at least one of: one or more signal configurations, one or more report configurations associated with one or more signal configurations, and/or one or more measurement filtering coefficients used to process the measurement results.

In some implementations, each signal configuration can comprise at least one of: a signal index, wherein the signal index is used to specify a signal to be measured by the network node and sent from the wireless communication device, wherein the signal index includes at least one of: reference signal (RS) index, logic index, or preamble index; information used to generate and initialize a sequence or an RS sequence; and/or information indicating a resource for the signal comprising at least one of: Random Access channel (RACH) occasion, frequency resource information, time resource information, bandwidth part (BWP) identity, subcarrier space (SCS), cell index or cell identity (ID), port information used to measure the signal, and/or one or more beam information used to measure the signal, wherein the one or more beam information comprises at least one of beam information for an access link or beam information for a backhaul link, wherein the access link includes a first access link from the network node to the wireless communication device and a second access link from the wireless communication device to the network node, and wherein the backhaul link includes a first backhaul link from the wireless communication node to the network node and a second backhaul link from the network node to the wireless communication node.

In some implementations, the frequency resource information can comprise at least one of a start Physical Resource Block (PRB), a start resource element (RE), an end PRB, an end RE, an RB offset or an RE offset, a number of PRBs or a number of REs, a frequency shift, a frequency offset, an Absolute Radio Frequency Channel Number (ARFCN), and/or a Global Synchronization Raster (GSCN). In some implementations, the time resource information can comprise at least one of: a periodicity, a slot offset, a start slot, a start symbol, a number of slots, a number of symbols, a start and length indicator value (SLIV), a pattern, a time domain resource allocation (TDRA) index, and/or a duty cycle.

In some implementations, the one or more beam information for the one or more signal configurations may be same or different. In some implementations, each report configuration can comprise at least one of: a measurement report index, wherein the measurement report index is used to specify a report configuration, and wherein the measurement report index is a logic index, a report type, wherein the report type includes at least one of: an event-triggered report or a periodic report, an indication on whether to include beam level measurement results in a report, wherein the beam level measurement results are the results measured by the network node using a beam information, a maximum number of beam level measurement result value or the number of beam level measurement result value included in the report for each measured signal, and/or one or more measurement filtering coefficients used to process measurement results.

In some implementations, when the report type is the event-triggered report, the one or more report configurations can comprise at least one of: event identity (ID) used to specify an event for measurement by the network node, a maximum number of measured signals to be included in the report, a number of reports, report quantity comprising at least one of: reference signal received power (RSRP), received signal strength indicator (RSSI), reference signal received quality (RSRQ), and/or signal-to-interference noise ratio (SINR) (or signal-to-noise interference ratio), a report interval indicative of an interval between reports, a threshold value used for the network node to determine whether to trigger the event-triggered report, a time when one or more criteria for an event are to be satisfied to trigger the event-triggered report, an indication to indicate whether the network node shall initiate a report procedure when a leaving condition is satisfied for a measured signal, and/or a parameter used for at least one of an entry condition and/a leave condition of an event-triggered report condition.

In some implementations, when the report type is the periodic report, the one or more report configurations can comprise at least one of: a maximum number of measured signals to be reported in the report, a number of reports, a report quantity comprising at least one of: reference signal received power (RSRP), received signal strength indicator (RSSI), reference signal received quality (RSRQ), or signal-to-interference noise ratio (SINR), a report interval indicative of an interval between periodic reports, a threshold value used for the network node to determine whether to trigger the periodic report.

In some implementations, an association between the one or more signal configurations and one or more report configurations can include at least one of: each signal configuration is associated with one or more report configurations, and/or each report configuration is associated with one or more signal configurations.

In some implementations, the network node can determine, responsive to measuring the signal, an on/off state of the network node according to measured results of the signal. In some implementations, the determining is performed according to at least one of following conditions: comparing, by the network node, the measured results of the signal with one or more thresholds; a number of detected signals; comparing, by the network node, the number of detected signals with one or more specific values; and/or whether the signal is detected.

In some implementations, at least one of: the one or more specific values for different signals are same or different; the one or more specific values are predefined for the network node via an operations, administration, and maintenance (OAM); and/or the one or more specific values are configured to the network node from the wireless communication node via at least one of a radio resource control (RRC) signal, a downlink control information (DCI) signal, and/or a medium access control element (MAC CE) signal.

In some implementations, the network node can send/transmit/provide an indication indicating the on/off state of the network node to the wireless communication node. In some implementations, the network node can report/indicate, responsive to measuring the signal, a measurement result performed based on the one or more configurations to the wireless communication node.

In some implementations, the measurement result can comprise at least one of: signal index; signal strength including at least one of reference signal received power (RSRP), received signal strength indicator (RSSI), reference signal received quality (RSRQ), signal-to-interference noise ratio (SINR), or signal-to-interference ratio (SIR); the signal strength that is an average strength determined based on a plurality of beam level signal strengths, wherein the plurality of beam level signal strengths are measured by the network node using a specific beam; one or more beam level signal strengths or one or more associated beam information; a strongest beam level signal strength value of a plurality of beam level measured result values or associated beam information; and/or an N strongest beam level measurement result values or a corresponding N beam information, wherein N represents a number of reported beam level signal strengths, determined via at least one of: the N is configured to the network node or the wireless communication node via operations, administration, and maintenance (OAM), the N is configured from the wireless communication node to the network node via at least one of a radio resource control (RRC) signaling, a downlink control information (DCI) signaling, or a medium access control element (MAC CE) signaling; an integer value determined according to a comparison between the signal strength and one or more thresholds; and/or one or more integer values determined according to a comparison between a beam level signal strength and one or more thresholds and one or more associated beam information.

In some implementations, the signal strength can be obtained/received/acquired after processing by Layer 1 filtering or Layer 3 filtering. In some implementations, at least one of: the one or more thresholds are provided to the network node from the wireless communication node via at least one of: the RRC signaling, the MAC CE signaling, or the DCI signaling, the one or more thresholds are provided to the network node via the OAM, and/or the one or more thresholds are determined based on a capability of the network node and reported from the network node to the wireless communication node.

In some implementations, the network node can send an indication to the wireless communication node to indicate whether there is at least one wireless communication device under a serving area of the network node according to a measurement result of the network node. In some implementations, the measurement result or the indication may be transmitted via at least one of: uplink control information (UCI) via a transmission in physical uplink control channel (PUCCH) or physical uplink shared channel (PUSCH), and/or medium access control control element (MAC CE) signaling via a transmission in PUSCH.

In some implementations, the network node can receive an explicit indication from the wireless communication node indicating an on/off state of the network node. In some implementations, a granularity of an on/off state indication can include at least one of: the on/off state indication used for one or more network nodes, the on/off state indication used for one or more beams of the network node, wherein the one or more beams of the network node comprise at least one of: beams for at least one access link, or beams of at least one backhaul link, the on/off state indication used for at least one of a plurality of links of the network node, wherein the plurality of links comprises at least one of a first backhaul link, a second backhaul link, a first access link, a second access link, a first control link from the wireless communication node to the network node, and/or a second control link from the network node to the wireless communication node, the on/off state indication used for one or more panels of the network node, the on/off state indication used for one or moreports of the network node, the on/off state indication used for one or morebands of the network node, and/or the on/off state indication used for one or moresignal types of the network node.

In some implementations, the indication may be sent through/via at least one of: a radio resource control (RRC) signaling, a downlink control information (DCI) signaling, or a medium access control element (MAC CE) signaling. In some implementations, when the network node detects/identifies that an explicit on/off indication is not received from the wireless communication node, the network node can determine an on state of the network node until the network node receives control information from the wireless communication node used to control a forwarding operation of the network node.

In some implementations, when the network node detects that an explicit on/off indication is not received from the wireless communication node, the network node can determine an off state of the network node until the network node receives beam information from the wireless communication node used to control a forwarding operation of the network node. In some implementations, when the network node receives beam information from the wireless communication node to control a forwarding operation of the network node, an on/off state of the network node may be implicitly indicated according to the received beam information.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates a structure of example implementations for wireless communication device (e.g., UE) detection, in accordance with some embodiments of the present disclosure; and

FIG. 6 illustrates a flow diagram of an example method for wireless communication device detection, in accordance with an embodiment of the present disclosure.

### DETAILED DESCRIPTION

### 1. Mobile Communication Technology and Environment

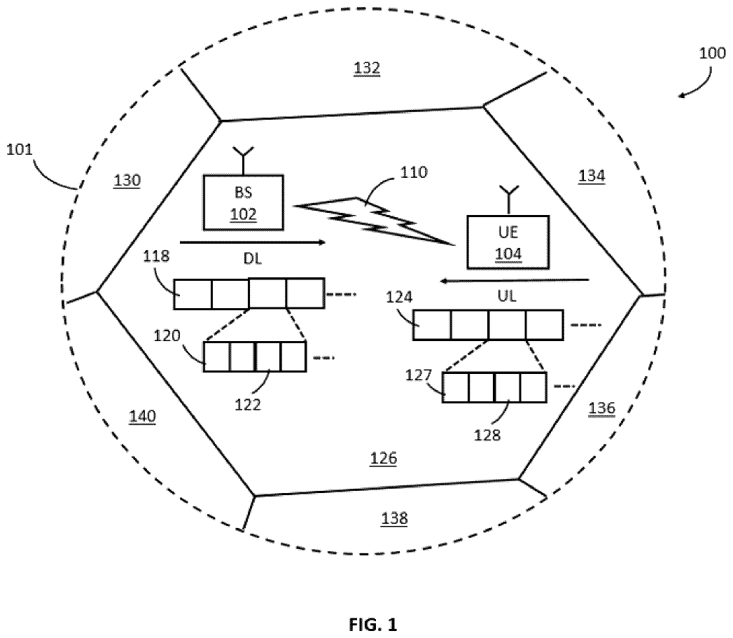

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

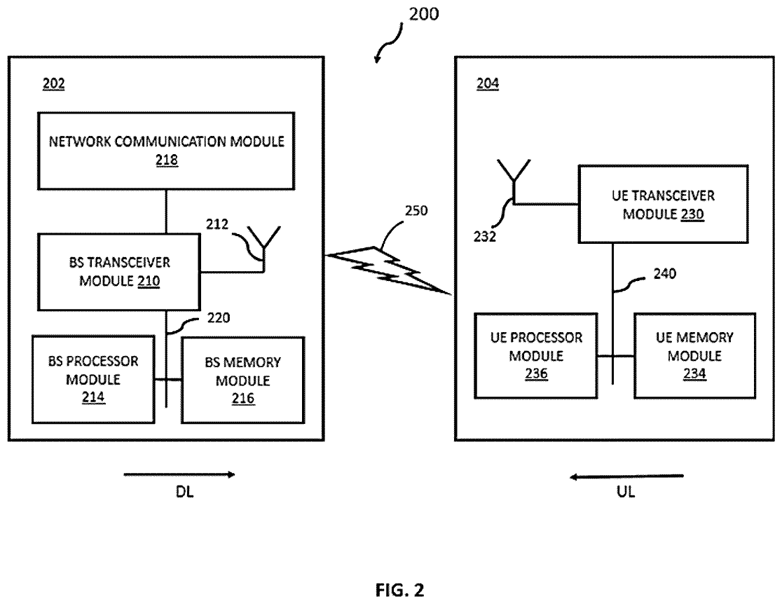

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Interference Measurement for Network Nodes (e.g., SN)

As certain systems (e.g., 5G new radio (NR), Next Generation (NG) systems, 3GPP systems, and/or other systems) move/transition to relatively higher/greater frequency (e.g., around 4 GHz for FR1 deployments and above 24 GHz for FR2), degradation in the propagation (e.g., communication or transmission) conditions may be observed/identified compared to relatively lower frequencies. In such cases, it may be challenging to address the propagation degradation due to the usage of the relatively higher frequency. As such, densification (e.g., increase in density) of cells may be desired. In certain scenarios, the deployment of regular full-stack cells may not be available (e.g., no availability of backhaul) and/or viable, such as when it is preferred. In certain systems, radio frequency (RF) repeaters with full-duplex amplify-and-forward operation can be used to provide blanket coverage in cellular network deployments. However, the utilization of RF repeaters may amplify both signals and noises, which may increase the interference in such systems.

To minimize or avoid the amplification of noises, a network-controlled repeater (NCR) can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration. Similar mechanisms or techniques for controlling the amplification of signals (and/or noise) can be performed by similar types of network devices as discussed herein, for example.

The NCR can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to NCR, smart repeater, enhanced RF repeaters, RIS, and/or integrated access and backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.). One or more SNs can be deployed to improve coverage and some SN FU can be activated (e.g., turned on) or deactivated (e.g., turned off) depending on whether there is a forwarding operation for the SN FU, such as according to whether there is at least one UE under the coverage area of the SN.

In certain scenarios, one or more SNs can be deployed to improve the data rate of the UEs 104. For example, the UE 104 can establish a connection with the BS 102 via the SN, where the SN can be an intermediary between the UE 104 and the BS 102. In such cases, the SN can be used to improve the data rate (e.g., the transmission of data) of UEs 104. It may be challenging to determine which of the SNs is suitable to serve at least one UE 104, such that other SNs can be turned off to reduce potential interference and energy consumption. Therefore, in cases with multiple SNs deployed within a certain area, the systems and methods of the technical solution discussed herein can provide (or introduce) mechanisms and/or techniques to determine whether one or more SNs should serve one or more UEs 104, such that an on/off command (e.g., demand) can be sent to the one or more SNs according to the determination.

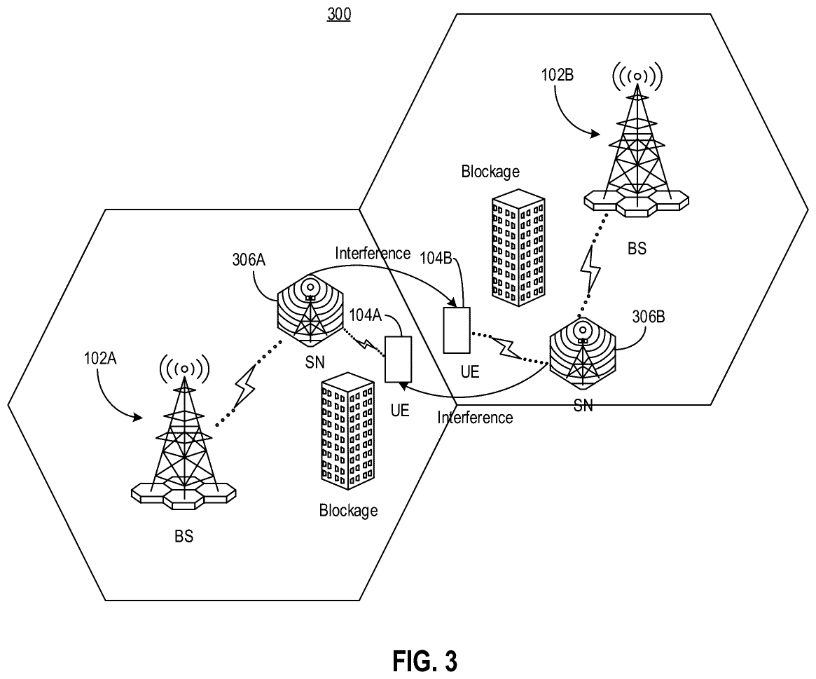

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 306A-B (e.g., sometimes labeled as SN(s) 306), such as when there are blockages between the BS(s) 102 and the UE(s) 104. The systems and methods can provide an SN 306 configured to measure signals communicated/received/obtained from the UEs 104 to detect whether the UEs 104 are under the coverage area of the SN 306. In some cases, certain features or functionalities of the SN 306 may be similar to the UE 104. The systems and methods of the technical solution can provide various measurement configurations for the UE 104 to measure signals (e.g., sounding reference signals (SRS), among other types of signals) of other UEs 104. For example, the UE 104 can measure cross-link interference (CLI). The systems and methods (or the network, such as the BS 102 or the SN 306) can configure the UE 104 to report/provide/indicate the CLI measurement information to at least one of the SN 306 and/or the BS 102 based on at least the SRS resources. The CLI measurement information based on the SRS resources can include at least one of the following
Measurement results per SRS resource; and/or
SRS resource(s) indexes.

In some cases, the network may configure the UE 104 to report the CLI measurement information based on CLI-received signal strength indicator (RSSI) resources, including at least one of the following:
Measurement results per CLI-RSSI resource; and/or
CLI-RSSI resource(s) indexes.

In various implementations, the CLI measurement procedures can include multiples steps, such as steps 1 and 2 discussed herein. In step 1, the BS 102 can configure the UE 104 with CLI measurement configuration. The measurement configuration can include at least one of the following parameters:
1) Measurement object configured in measObjectCLI-r16 information element (IE). The measurement object can indicate the frequency and/or time location of SRS resources and/or CLI-RSSI resources, and/or subcarrier spacing of SRS resources to be measured by the UE 104.
2) Report configuration configured in ReportConfigNR IE. The report configuration (e.g., sometimes referred to as measurement reporting configuration) can include, correspond to, or be a part of a list, where the list can include one or more reporting configurations per measurement object. Each measurement reporting configuration can include/comprise at least one of the following:
   Reporting criterion: the criterion that can trigger the UE 104 to send a measurement report. The reporting criterion can trigger the UE 104 to send the measurement report periodically (e.g., at predetermined time intervals) or as a single event (e.g., in response to or at a predefined time instance after receiving the criterion).
   Reference signal (RS) type: including or corresponding to at least one of SRS and/or CLI-RSSI resources, etc.
   Reporting format: can be used to configure the reported measured results as reference signal received power (RSRP) value and/or received signal strength indicator (RSSI) value, among other types of values.
3) Measurement identities (IDs): for measurement reporting. A list of measurement identities can be included, where each measurement identity can link a measurement object with a respective reporting configuration.
4) Quantity configurations: the quantity configuration can indicate/define/represent the measurement filtering configuration used for event evaluation/determination and/or related reporting, and/or for periodical reporting of the measurement.

In step 2, after receiving the configuration, the UE 104 can perform or execute the measurement operation. If there is at least one (e.g., applicable) CLI measurement resource to report, the UE 104 can initiate the reporting procedure/operation. For example:
1) For each SRS resource included in the measResultCLI, the associated SRS resource ID can be included in the report. The SRS resource ID can be used to identify or represent the SRS resource, for example. The SRS RSRP result can be included in the layer 3 filtered measured results. In some cases, the SRS resource IDs associated with respective SRS RSRP results can be included in the layer 3 filtered measured results in decreasing/decremental order, e.g., the highest/most interfering SRS resource (e.g., SRS resource associated with the highest interference measurement) can be included as the first SRS resource ID in the list. In some other cases, the SRS resource IDs associated with respective SRS RSRP results can be included in the layer 3 filtered measured results in incremental/increasing order, e.g., the lowest/least interfering SRS resource can be included as the first SRS resource ID in the list.
2) For each CLI-RSSI resource included in the measResultCLI, the associated RSSI resource ID can be included in the report. The RSSI resource ID can be used to identify or represent the CLI-RSSI resource, for example. The CLI RSSI result can be included in the layer 3 filtered measured results, such as in decremental order (e.g., the most interfering CLI-RSSI resource can be included first) or incremental order (e.g., the least interfering CLI-RSSI resource can be included first) based on the configuration of the UE 104, for example.

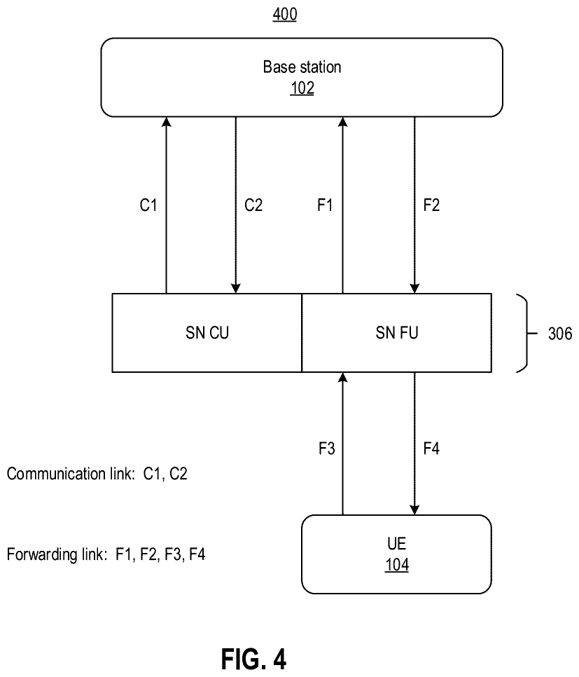

Referring to FIG. 4, depicted is a schematic diagram 400 of transmission links between BS 102 to SN 306 and SN 306 to UE 104. The SN 306 can include or consist of at least two units or functional parts/components (e.g., sometimes referred to as function entities), such as the communication unit (CU) (e.g., SN CU) and the forwarding unit (FU) (e.g., SN FU). The units of the SN 306 can support different functions for communication with at least one of the BS 102 and/or the UE 104. A first unit (or function entity) of the SN 306 may refer to the SN CU and a second unit (or function entity) of the SN 306 may refer to the SN FU or vice versa, in some cases. For example, the SN CU (e.g., first unit) can be a network-controlled repeater (NCR) MT. In another example, the SN FU (e.g., second unit) can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 306 and the SN 306 to UE 104 as shown in FIG. 4 can be defined/described/provided as follows:
C1: Control link (C-link) from SN CU to BS;
C2: Control link (C-link) from BS to SN CU;
F1: Backhaul link from SN FU to BS;
F2: Backhaul link from BS to SN FU;
F3: Access link from UE to SN FU; and
F4: Access link from SN FU to UE.

Control link (e.g., sometimes referred to as a communication link) can refer to or mean that the signal from one side will be detected and decoded by the other side, so that the information transmitting in/via the control link can be utilized to control the status of forwarding links (e.g., backhaul links and/or access links, F-link). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

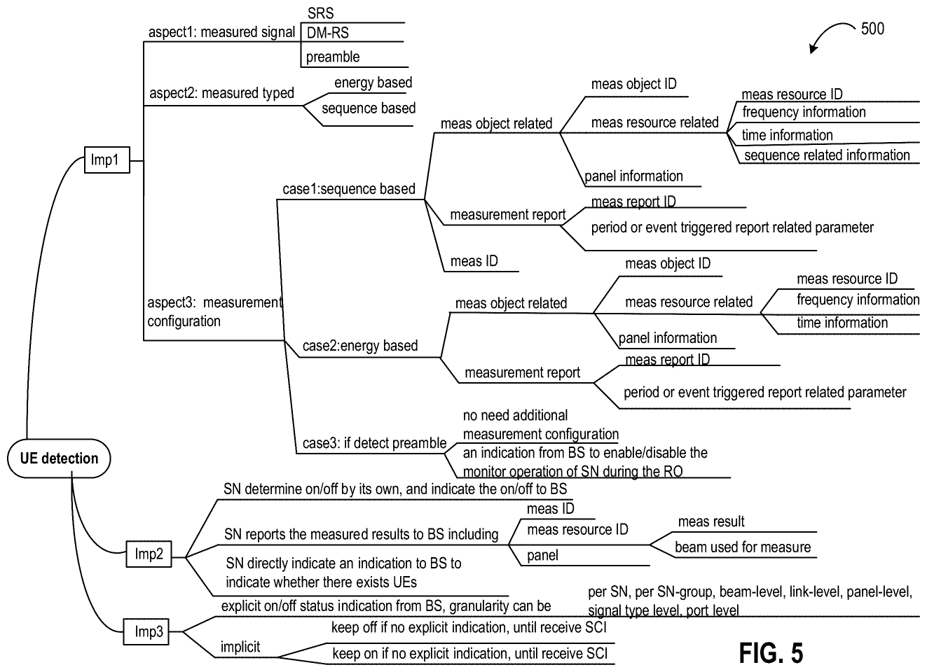

Referring to FIG. 5, depicted is a structure 500 of example implementations for UE detection. The structure 500 can include or indicate the various example implementations of the technical solution discussed herein, including, but not limited to, a first example implementation, a second example implementation, and a third example implementation, for example.

### Example Implementation 1: BS Configures SN to Measure Signals from UE

In various implementations, the BS 102 can configure/instruct the SN 306 to measure signals from individual UEs 104 to determine whether the UEs 104 are within the serving area of the SN 306. Various aspects or configurations can be considered or utilized to measure the signals from the UEs 104.

### Example Aspect 1 of Example Implementation 1: Types of Signal to Measure by the SN

In some aspects, for the SN 306 to perform the measurement operation for detecting whether one or more UEs 104 are under the coverage area of the SN 306 (e.g., to serve the UE(s) 104), the SN 306 can be configured to measure/analyze the signal transmitted from/by the UE 104. In this case, at least one of the following example configurations (e.g., example configurations 1-3) or cases can be considered, performed, or utilized.

### Example Case 1 of Example Aspect 1

In various cases, the SN 306 can be transparent to the UEs 104. In these cases where the SN 306 is transparent to the UE 104, the UE 104 may exhibit or follow legacy behavior, such that the UE 104 can operate normally (e.g., no additional procedures/steps to be performed by the UE 104), for example. Considering the different states or statuses of the UE 104 (e.g., the UE 104 being in different states or statuses), the following configurations or operations can be considered or performed:

### Example Configuration 1 of Example Case 1

In some configurations, the signal to be measured by the SN 306 can include or be a reference signal (RS) transmitted by the UE 104. For example, when the UE 104 operates in an RRC_connected state, and the BS 102 is configured to introduce/indicate/appoint the SN 306 to serve the UE 104 to improve/enhance the data rate (e.g., improve transmission/communication), the BS 102 can configure the SN 306 to measure the RS transmitted from the UE 104. The RS from the UE 104 can include at least one of SRS, demodulation reference signal (DM-RS), phase tracking reference signal (PT-RS), etc.

### Example Configuration 2 of Example Case 1

In some configurations, the signal to be measured by the SN 306 can include a preamble transmitted/provided by/from the UE 104. For example, when the UE 104 operates in the RRC_idle state, the UE 104 may send/transmit/signal the preamble to initiate an initial access procedure. Because the SN CU can perform similar features or functionalities as the UEs 104, the SN CU may receive cell-specific physical random access channel (PRACH) configuration used by the one or more UEs 104. In such cases, if the SN 306 measures the preamble from or provided by the one or more UEs 104, the BS 102 may not be required to send/provide the additional PRACH-related resource configuration to the SN 306, thereby reducing network traffic and/or resource consumption.

### Example Configuration 3 of Example Case 1

In some configurations, the signal to be measured by the SN 306 can include physical uplink control channel (PUCCH) and/or physical uplink shared channel (PUSCH) signal from the UE 104. For example, when the UE 104 operates in RRC_connected state, and the UE 104 can send/transmit at least one PUCCH and/or PUSCH signal to the BS 102. Based on the PUCCH and/or PUSCH signal, the BS 102 can configure the corresponding frequency-related information and/or time-related information to the SN 306 for the measurement (e.g., to perform measurement of the signal).

### Example Case 2 of Example Aspect 1

In various cases, the SN 306 may be non-transparent to the UEs 104. In such cases, the UE 104 may send at least one dedicated signal to the SN 306. For example, the signal can be dedicated to/for the SN 306, such that when the SN 306 receives the signal, the SN 306 can determine its on/off state. In this example, the SN 306 may not report (or avoid reporting) the measurement results to the BS 102, such that the BS 102 is not required to determine the on/off state of the SN 306. In some other cases, when or after the UE 104 sends the dedicated signal to the SN 306, the SN 306 may send the measurement results to the BS 102, such as for the BS 102 to determine the on/off state of the SN 306. In this case, the BS 102 can determine and provide an indication of the on/off state for the SN 306. At least one of the following configurations can be considered or implemented:

### Example Configuration 1 of Example Case 2

In some configurations, the signal to be measured by the SN 306 can include a dedicated preamble used for UE detection. The dedicated preamble can be transmitted in a dedicated resource from the UE 104 to the SN 306. The dedicated resource can include at least one of: a time domain resource of a PRACH occasion, a frequency domain resource of the PRACH occasion, and/or a (e.g., dedicated) preamble index, among others. The dedicated resource may be configured to the SN 306 and/or the UE 104.

### Example Configuration 2 of Example Case 2

In some configurations, the signal to be measured by the SN 306 can include a reference signal (RS) with a dedicated/specific configuration for UE detection. For example, the reference signal transmitted with a dedicated or specific port index can be used for UE detection. In another example, the reference signal transmitted with a dedicated or specific RS index can be configured for UE detection (e.g., configured for the SN 306 to perform the UE detection or signal measurement).

### Example Configuration 3 of Example Case 2

In some configurations, the signal to be measured by the SN 306 can include a dedicated signal or sequence for UE detection. The dedicated sequence can include or correspond to at least one of an on-off keying (OOK) sequence, computer-generated sequence (CGS), and/or low peak-to-average-power ratio (PAPR) sequence, a Zadoff-Chu (ZC) sequence, and/or a pseudo-random sequence, etc.

### Example Configuration 4 of Example Case 2

In some configurations, the signal to be measured by the SN 306 can include a dedicated PUCCH transmission for UE detection, and/or a dedicated PUSCH transmission for UE detection.

### Example Aspect 2 of Example Implementation 1

In some aspects, the SN 306 can determine the type/kind of measurement to perform/execute/initiate. At least one of the following configurations (e.g., example configurations 1 and/or 2) can be considered/utilized for the measurement type of or performed by the SN 306:

### Example Configuration 1 of Example Aspect 2

In some configurations, the SN 306 may not need or be required to decode the signal transmitted from the UE 104. In this case, the SN 306 can perform RSSI measurement for the signal transmitted by/from the UE 104.

### Example Configuration 2 of Example Aspect 2

In some configurations, the SN 306 may decode the corresponding signal transmitted by the UE 104. Subsequently, the SN 306 can perform at least one of reference signal received power (RSRP), reference signal received quality (RSRQ), signal-to-interference noise ratio (SINR) measurement, and/or signal-to-interference ratio (SIR), among other measurements, for signals transmitted from/by the UE 104.

### Example Aspect 3 of Example Implementation 1

In various aspects, the SN 306 can be configured with at least one measurement configuration (e.g., measurement configuration known to the SN 306). If the SN 306 is to perform the signal measurement on one or more signals from the UE 104, the SN 306 may be configured with (e.g., the SN 306 may know) the resource information used in/by the transmitted signal. In some cases, if the SN 306 is to perform the reporting of the measurement result to the BS 102, the SN 306 may be configured with (e.g., the SN 306 may know) the report content (e.g., types of content of the report) and/or report format-related information, such as to generate and provide the report to the BS 102. In these aspects, the measurement configuration to send to or configure for the SN 306 can include, but is not limited to, at least one of the following example information (e.g., example information 1-3):

### Example Information 1 of Example Aspect 3

In various implementations, one or more signal configurations can be provided or configured for the SN 306. The signal configuration can be used to specify/indicate the resource information for the SN 306 to measure the signal transmitted by/from the UE 104. For each signal configuration, at least one of the following information can be configured for/to the SN 306:
1) At least one signal index. The signal index can be used to specify a signal to be measured by the SN 306 and/or to be sent from the UE 104. The format of the signal index can include one of: RS index, logic index, and/or preamble index, etc.
2) Information used to generate and/or initialize the sequence and/or the RS sequence. The sequence can include a dedicated sequence for the SN 306 (e.g., as described hereinabove, the UE 104 may be non-transparent to the SN 306, hence, a dedicated sequence can be transmitted to the SN 306), and the RS sequence (e.g., when the UE 104 is transparent to the SN 306, the UE 104 can send the SRS to the BS 102, and the BS 102 can configure the SN 306 to measure the SRS transmitted from the UE 104, hence, the RS sequence related information can be informed to the SN 306).
3) Information used to indicate the resource information for the signal. This information can include at least one of the following:
   a. Frequency resource information. The frequency resource information can include at least one of a start frequency position, an end frequency position, a number of physical resource blocks (PRBs) and/or REs, the frequency offset, and/or the frequency shift, absolute radio frequency channel number (ARFCN), global synchronization raster (GSCN), etc.
      i. For example, the format of the start frequency position can include or correspond to at least one of a start PRB, a start resource element (RE), PRB and/or RE offset compared to a reference point (e.g., point A, a start of the bandwidth part (BWP)), etc.
      ii. In another example, the format of the end frequency position can include or correspond to at least one of an end/last PRB, an end RE, RB and/or RE offset compared to a reference point (e.g., point A, a start of a BWP), etc.
      iii. In yet another example, the format of frequency offset can be at least one of a number of PRBs and/or a number of REs offset compared to a reference point.
   b. Time resource information. The time resource information can include at least one of periodicity, slot offset, the start slot and/or symbol, the number of slots and/or symbols, start and length indicator value (SLIV), a pattern, a time domain resource allocation (TDRA) index, a duty cycle, etc.
      i. For example, the format of the start slot can be the slot index and/or slot offset compared to a reference slot.
      ii. In another example, the format of the start symbol can be the symbol index and/or symbol offset compared to a reference point (e.g., the first symbol in a slot, or the last symbol in a slot).
   c. Subcarrier spacing (SCS).
   d. Cell ID (e.g., index). In some implementations, the cell ID/index can be used to determine the cell that the configured BWP belongs to. In some implementations, this parameter (e.g., cell ID) may or may not be configured, depending on the configuration. In cases where this parameter is not configured, the primary cell can be used as a default cell, for example.
   e. Bandwidth part (BWP) ID/index. In some implementations, the BWP can be used to derive, determine, or identify the reference point of the RS resource.
   f. One or more beam information used by the SN 306 for UE detection. The beam information can include the one or more beam indexes of the access link and/or one or more beam information (e.g., beam index, TCI state, etc.) of the backhaul link. In some implementations, for each measured signal, one or more beam information may be used. In some implementations, the beam information used for the different measured signals can be the same or different (e.g., between the different measured signals).
   g. One or more panel information used by the SN 306 for UE detection. The panel information can include the one or more panel information (e.g., panel ID) of the access link and/or one or more panel information (e.g., panel ID) of the backhaul link. In some implementations, for each measured signal, one or more panel information may be used. In some implementations, the panel information used for the different measured signals may be the same or different.
   h. One or more port information used to measure the signal. The port information can include or correspond to the one or more port information of the access link and/or one or more port information of the backhaul link. In some implementations, for each measured signal, one or more port information may be used. In some implementations, the port information used for the different measured signals can be the same or different.
   i. Random access channel (RACH) occasion.

### Example Information 2 of Example Aspect 3

In various implementations, one or more report configurations can be provided or configured for the SN 306. If the SN 306 is to report the measurement results (e.g., results from measuring the signal) to the BS 102, the SN 306 may be configured (e.g., know or may have information regarding) the type/kind of report and/or the format of the measured results to provide or include as part of the report to the BS 102. In such implementations, for each report configuration, at least one of the following information can be configured to/for the SN 306:
1) One or more measurement report IDs. Each measurement report ID can be used to identify a report configuration.
2) The report type. The report type can include or be a periodic and/or an event triggered (e.g., reporting may be triggered responsive to a certain event).
   a. For example, if the report type is periodic, the related parameters to enable the periodic report can be configured to the SN 306. The related parameter can include at least one of: a maximum number of measured signal to be reported in the report, the number of reports, the measurement quantities to be included in the report (e.g., the RSRP, RSRQ, SINR, RSSI, and/or SIR, etc.), the report interval specifying the interval between periodic reports, the threshold value associated with the selected trigger quantity. In this case, the threshold value can include one or more specific values to be used for comparison with the measured results. The specific values can be used for the SN 306 to determine whether to trigger a periodic report, e.g., when the measured results is greater than the threshold value, the SN 306 can report the results.
   b. In another example, if the report type is event-triggered, the (e.g., current) event in the specification can be reused for the measurement and/or a new event can be defined for the measurement. The related parameter to enable the event triggered report can be configured to the SN 306. The related parameter can include at least one of: event ID, the maximum number of measured signals to be included in the report, the number of reports, the measurement quantities to be included in the report (e.g., the RSRP, SINR, RSRQ, RSSI, and/or SIR, etc.), the report interval specifying the interval between reports, the threshold value associated with the selected trigger quantity, the time (e.g., time range, duration, or instance) during which specific criteria for the event is to be met/satisfied to trigger a reporting (e.g., for SN 306 to initiate the reporting or generate the report), the indication to indicate whether the SN 306 is to initial the report procedure when a leaving condition is met for a measured signal, hysteresis parameter used within the entry and/or leave condition of an event triggered reporting condition, etc.
3) An indication regarding whether to report the beam level measurement results in the report. The beam level measurement results value can include or correspond to the signal strength that the SN 306 measured using the specific or indicated beam.
4) The maximum number of beam level measurement results value that can be reported for a measured signal.
5) One or more measurement filtering coefficient used to process the measurement results.

### Example Information 3 of Example Aspect 3

In various implementations, one or more measurement filtering coefficients used to process the measurement results can be configured or provided to the SN 306. In some implementations, for the different measured signals, the measurement filtering coefficient can be the same or different. In some implementations, for the different measurement quantities, the measurement filtering coefficient may be the same or different.

### Example Information 4 of Example Aspect 3

In various implementations, if the measured signal is the RS from the UE 104, and the measurement quantity is at least one of: RSRP, RSRQ, SINR, and/or SIR, among others, the SN 306 may decode the RS from the UE 104. In such cases, the configuration related to the RS may be configured to/for the SN 306. The configuration related to the RS can include at least one of:
1) The information used to generate and/or initialize the RS sequence. For example, if the signal used for the measurement is SRS, the sequence ID used to initialize pseudo random group and/or sequence hopping may be configured to the SN 306. In another example, if the signal used for the measurement is DM-RS, the scrambling ID0 (e.g., first ID) and/or scrambling ID1 (e.g., second ID) used for DM-RS scrambling initialization may be used to indicate to the SN 306.
2) The RS configuration-related parameter can be configured to the SN 306.
   a. For example, if the SN 306 is to measure the SRS transmitted from the UE 104. The current SRS resource-related configuration parameter (e.g., the number of ports, and/or the antenna port index) may be configured to the SN 306. In some implementations, in cases where this configuration is used for measurement operation of the SN 306, some of the parameters and/or fields can be pre-defined as a specific value. For example, the frequency hopping, sequence group hopping, and/or sequence hopping field can be configured as disabled/inactive.
   b. In another example, if the measurement signal is the dedicated preamble and/or dedicated sequence from the UE 104, the measurement quantity can include or correspond to at least one of RSRP, RSRQ, SINR, etc.

### Example Information 5 of Example Aspect 3

In various implementations, the information can include signal-to-interference ratio (SIR). At least one of the following information may be configured or provided to the SN 306:
1) Information used to generate the sequence of measured signal. For example, if the signal used for the measurement is SRS, the sequence ID used to initialize pseudo random group and/or sequence hopping can be configured to the SN 306. In another example, if the signal used for measurement is DM-RS, the scrambling ID0 and/or scrambling ID1 used for DM-RS scrambling initialization can be used to indicate to the SN 306.
2) Preamble index. For example, if there is a dedicated preamble used for the measurement of the SN 306, the dedicated preamble index may be configured to the SN 306.

### Example Information 6 of Example Aspect 3

In various implementations, if the measurement signal is based on preamble transmitted from UEs 104:
1) If the SN 306 is transparent to the UEs 104, the measured preamble can be a legacy configuration used for the random access procedure. Since the SN CU may perform or exhibit similar features or functionalities as certain UEs 104, the SN CU may receive the cell-specific PRACH-related configuration from the BS 102. In some implementations, the SN 306 may monitor during various the PRACH occasions to detect the preamble sent by the UEs 104. Additionally or alternatively, the BS 102 may indicate to the SN 306 whether the SN 306 is to monitor and/or measure the preamble transmitted from the UEs 104 during the PRACH occasions. For example, a new bit can be configured by the BS 102 to the SN 306 to enable or disable the monitoring operation of the SN 306 during the PRACH occasion.
2) If the SN 306 is non-transparent to the UEs 104, a dedicated preamble with dedicated PRACH occasion resource configuration can be considered or provided for the measurement. In this case, the dedicated resource can include at least one of: the time resource, the frequency resource, and/or the preamble index. The dedicated resource can be configured to the SN 306 and/or the UEs 104.
3) For each signal configuration, there may be one or more associated report configurations. For different measurement resource configurations, the associated report configuration can be the same or different. Each report configuration can be associated with one or more signal configurations.

### Example Aspect 4 of Example Implementation 1

In various aspects, the abovementioned configuration parameters configured to/for the SN 306 can be carried/communicated/signaled via at least one of an operations, administration, and maintenance (OAM) signal, a system information (SI) signal, a radio resource control (RRC) signal, a downlink control information (DCI) signal, and/or a medium access control control element (MAC CE) signal, among other types of signals/signalings. The different configuration parameters can be configured in the same signaling and/or different signaling. For example, the configuration parameters can be carried:
1) Through OAM signal. The one or more configurations indicated to the SN 306 can be configured by the network (e.g., BS 102) via the OAM.
2) Through SI signal. The one or more configurations can be configured by the BS 102 via SI. In this case, the configuration for the measurement operation of the SN 306 can be the same for various SNs 306 in a cell.
3) Through RRC signal. The one or more configurations can be configured through RRC message.
4) Through DCI signal. One or more new DCI fields can be defined/configured, and/or at least one existing DCI field can be re-interpreted/reconfigured/re-defined.
5) Through MAC CE signal. At least one new MAC CE can be defined.
6) Through RRC and DCI signals. At least one of the one or more configurations can be configured in an RRC message/signal, and/or at least one of the configurations can be activated/enabled by the DCI signal.
7) Through RRC and MAC CE signals. At least one of the one or more configurations can be configured in an RRC message/signal, and/or at least one of the configurations can be activated/enabled by the MAC CE signal.
8) Through RRC, MAC CE, and DCI signals. At least one of the one or more configurations can be configured in the RRC message, a subset/portion of one or more configurations may be selected by or according to the MAC CE signal, and/or at least one of the configurations can be activated by the DCI signal.
9) Through OAM and DCI signals. The one or more configurations be configured by the BS 102 via the OAM signal. In some cases, one or more parameters of the one or more configurations can be updated by or according to the DCI signal.
10) Through OAM and MAC CE signals. The one or more configurations can be configured by the BS 102 via OAM signal. In some cases, the one or more configurations can be updated by the MAC CE signal.

### Example Implementation 2: SN Post-Measurement Operation

In various implementations, responsive to or after receiving the configuration (e.g., for signal measurement) from the BS 102, the SN 306 may initiate measurement of the signaling from the UEs 104 according to the configuration from the BS 102. After the measurement (e.g., post-measurement), the SN 306 may perform at least one of the following example configurations or operations.

### Example Configuration 1 of Example Implementation 2

In some configurations, the SN 306 can directly determine the on/off state/status (e.g., of the SN 306 itself). In various implementations, the determination of its on/off status can be based on or according to at least one of the following:
1) The measured results can be compared with one or more thresholds. According to the result of the comparison, the SN 306 can determine its on/off state. For example, if the SN 306 is non-transparent to the UEs 104, and the UE 104 send a dedicated signal that is used for measurement of/by the SN 306 (e.g., a dedicated preamble, a dedicated RS with a specific port index, a dedicated RS with a specific RS index, a dedicated signal or data sequence, and/or a dedicated PUCCH or PUSCH transmission, etc.), the SN 306 can measure the signal. In some implementations, one or more thresholds can be configured to the SN 306. The SN 306 can measure the signal and compare the result values (e.g., measurement results) with the threshold(s) to determine its on/off state. For example, if the measured results value is greater/larger than the threshold, the SN 306 may turn on or maintain activity of the transmission and/or reception operation on at least one of the forwarding links. The one or more thresholds can be predefined for the SN 306, and/or configured to the SN 306 by the BS 102 via at least one of RRC, MAC CE, and/or DCI signaling, among other types of signalings. In some cases, the one or more thresholds can be determined based on the capability of the SN 306.
2) The on/off state can be determined by the number of detected signals. For example, the UE 104 may send multiple dedicated sequences to the SN 306, and the SN 306 can count, identify, or determine the number of the detected sequences. If the number of the detected sequence is greater/larger than a specific value, the SN 306 can determine to turn on. The specific value can be predefined for the SN 306, and/or configured to the SN 306 by the BS 102 via at least one of RRC, MAC CE, and/or DCI signaling, among other types of signalings. In some cases, the specific value may be determined based on the capability of the SN 306. In some implementations, for the different signals, the specific value can be the same or different.
3) The on/off state can be determined according to whether the corresponding signal is detected. For example, the UE 104 may send a dedicated PUSCH transmission to the SN 306. If the SN 306 detects this dedicated signal (e.g., PUSCH transmission from the UE 104), the SN 306 can determine to turn on/activate. In some implementations, the dedicated signal sent from the UE 104 to the SN 306 can be representative of or correspond to a wake-up signal. In such cases, when the SN 306 receives this type/kind of dedicated/specific signal, the SN 306 can turn on. This specific/dedicated signal can be pre-defined to the SN 306 and/or the UE 104, and/or configured to the SN 306 and/or the UE 104 by the BS 102 via at least one of RRC, MAC CE, and/or DCI signaling, among other types of signalings.

In some implementations, the SN 306 may report the on/off status to the BS 102, such as after the determination of the on/off status/state of the SN 306. For example, in relatively high data rate scenarios, when the SN CU controls multiple SN FUs, if certain measured results of SN FU do not (or cannot) satisfy/meet the threshold (e.g., predefined or predetermined), the SN CU can determine that the corresponding SN FU may not be suitable for serving the one or more UEs 104. In this case, the SN CU can directly turn off or deactivate (e.g., power off) the corresponding SN FU. The SN CU can report to the BS 102, where the report can include information about/regarding the set of SN FU that is turned off/deactivated, for instance, subsequent to determining that the corresponding SN FU may not be suitable for serving the UE 104.

In another example, if the measured results of SN 306 do not satisfy the threshold, the SN CU may directly turn off the corresponding SN FU. In this example, if the BS 102 does not receive the measured results-related information (e.g., the measured RSRP and/or RSSI value, and/or the on/off status of the SN 306) from the SN 306, the BS 102 can determine that the corresponding SN FU is in the off status (e.g., SN 306 is deactivated).

### Example Configuration 2 of Example Implementation 2

In some configurations, the SN 306 can report the measured results to the BS 102. The reported measured results can include at least one of the following:
1) One or more/multiple signal indexes.
2) For each measured signal, the content of the reported measured results value can include or be at least one of:
   a. Signal strength. The format of the signal strength can include at least one of RSRP, RSRQ, SINR, SIR, and/or RSSI, among others. For example, if no beam information is configured (e.g., there is an absence of beam information configuration) for the measured signal or only one beam configuration is configured for the measured signal, the reported results for the measured signal may include a single signal strength.
   b. Signal strength that is an average strength calculated among (or determined based on) various beam level signal strengths. The beam level signal strength can be the signal strength measured by the SN 306 (e.g., network node) using the specific beam. For example, if multiple beams are configured for the SN 306 to be used for the measured signal, the reported results of the corresponding measured signal can include a signal strength value. The signal strength value can be a joint value or mean value determined using multiple beam level signal strength values. In some implementations, one or more thresholds can be configured by the BS 102 to/for the SN 306 via at least one of RRC, MAC CE, and/or DCI signaling, etc. In some cases, the threshold(s) can be configured to the SN 306 via the OAM. The threshold value can be used to compare with the one or more beam level signal strength values. In some implementations, the one or more beam level signal strength values that are higher/greater than the threshold value can be used to determine/compute the reported signal strength value. In some implementations, the one or more configured thresholds for each measured signal can be the same or different.
   c. One or more beam level signal strengths and/or one or more associated beam information. For example, if multiple beams are configured for the measured signal, the reported results of the corresponding measured signal can include one or more signal strengths and/or one or more associated beam information. The signal strength and associated beam information may be a one-to-one mapping. In some implementations, the reported results can include multiple pairs, where each pair can include a signal strength value and associated beam information. The maximum number of beam level signal strength that can be included in the report for each measured signal can be configured by the BS 102 to the SN 306.
   d. The strongest beam level signal strength (e.g., relatively highest signal strength value) among various beam level signal strengths and/or associated beam information.
   e. The N strongest beam level signal strength and/or the corresponding N beam information. The N can be the number of reported beam level signal strength. The N can be configured to the SN 306 and/or the BS 102 via OAM. In some cases, the N can be configured from the BS 102 to the SN 306 via at least one of RRC, MAC CE, DCI signaling, etc. For example, the BS 102 can configure to the SN 306 that only the first N strongest beam level signal strength value may be reported. In this case, the SN 306 can report the first N strongest beam level signal strength value among the various measured beam level signal strength values. In some implementations, if the total number of beam level signal strength values measured by the SN 306 is less than the N, the SN 306 can report various beam level signal strength values and/or associated beam information. In this case, the SN 306 may report only the strongest beam level signal strength value and/or the corresponding beam information.
   f. An integer value determined according to a comparison between the measured signal strength and one or more thresholds.
      i. For example, the RSRP value of the corresponding RS resource can be an integer value. In some cases, a pre-defined table can be used to map the measured quantity value to an integer value historically or previously reported in the measurement report. In some implementations, the current (e.g., existing) table can be reused, e.g., the current SRS-RSRP measurement report mapping table can be reused. In some other implementations, a new table can be predefined/predetermined or configured for the SN 306.
      ii. In another example, the reported results value can include or correspond to the measured signal status and/or measured signal level, such as obtained by comparing the signal strength value of the signal against/with a threshold value. For example, the signal strength value used for the comparison can be the raw measured value and/or the value that is obtained after processing the raw value via the layer 1 filtering and/or layer 3 filtering, among other types of filtering. In this example, one or more sets of thresholds may be configured/defined according to the different measured signalings. In each set of thresholds, one or more thresholds may be defined to determine the different levels of the measured signal. For instance, set 1 (e.g., a first set) can be for SRS measurement, and set 2 (e.g., a second set) can be for the preamble measurement, etc. In each set, different values of the thresholds may be used to determine the different status/levels of corresponding measured signal, such as shown in the example tables 1 and 2.

Example Table 1: Single Threshold for the Measured Signal

| Signal Level | For RSRP of SRS |
|---|---|
| 0 | E < Threshold 1 |
| 1 | Threshold 1 < E |

Example Table 2: Three Thresholds for each Measured Signal

| Measured Signal | | |
|---|---|---|
| Level/Status | For SRS | For preamble |
| 1 | E < Threshold 1 | E < Threshold 4 |
| 2 | Threshold 1 < E < | Threshold 4 < E < |
| | Threshold 2 | Threshold 5 |
| 3 | Threshold 2 < E < | Threshold 5 < E < |
| | Threshold 3 | Threshold 6 |
| 4 | E > Threshold 3 | E > Threshold 6 |

iii. In some cases, the one or more thresholds can be predefined for the SN 306, or configured for the SN 306 by the BS 102 via at least one of RRC, MAC CE, and/or DCI signaling, etc. In some other cases, the one or more thresholds may be determined based on or according to the capability or compatibility/support of/by the SN 306.
g. One or more integer values determined according to a comparison between the beam level signal strength and one or more thresholds, and one or more associated beam information. For example, the one or more thresholds can be predefined for the SN 306, and/or configured to the SN 306 by the BS 102 via at least one of RRC, MAC CE, and/or DCI signaling, among others. In some cases, the one or more thresholds can be determined based on the capability of the SN 306.

In some implementations, the signal strength value discussed hereinabove can include or be the value processed by layer 1 (L1) filtering and/or layer 3 (L3) filtering, or other types of filtering, for example. Given the different techniques/mechanisms of the content of reported measurement results, the type(s) of contents of the measurement results that the SN 306 is configured to report to the BS 102 can be determined or selected according to the OAM for the SN 306 and/or the BS 102, pre-defined to the SN 306 and/or the BS 102, and/or determined by the BS 102 to the SN 306 via at least one of RRC, MAC CE, and/or DCI signaling, etc.

### Example Configuration 3 of Example Implementation 2

In some configurations, the SN 306 can send/transmit/provide/signal an indication to the BS 102 indicating whether one or more UEs 104 are under or within the coverage area of the SN 306. For example, this indication provided by the SN 306 can include or correspond to one bit field. The bit value 1 may indicate/represent that there are one or more UEs 104 within the SN coverage area. The bit value 0 may indicate that there is no UE 104 within the SN coverage area. Depending on the configuration the bit value 0 may indicate that there are one or more UEs 104 within the SN coverage area, and the bit value 1 may indicate that there is no UE 104 within the SN coverage area, for example.

In some implementations, if the SN CU controls multiple SN FUs, and these SN FUs are located in different positions/locations, the SN 306 may report to the BS 102 whether there exist one or more UEs 104 under the coverage area of each SN FU. For example, a bit field can be used to indicate whether one or more UEs 104 are under SN FU's coverage area. The panel ID can be used to represent or indicate the SN FU information. In this case, one or more pairs (e.g., bit field and panel ID pairs) of {bit field, panel ID} can be used to indicate whether at least one UE 104 exists or resides under/within the corresponding SN FU's coverage area. In another example, a bitmap can be used to indicate whether one or more UEs 104 are under each SN FU's coverage area. For instance, for this bitmap, each bit may be used to represent an SN FU. Depending on the configuration, the bit value 1 (or 0) can represent that there are one or more UEs 104 within the corresponding SN FU's coverage area, and the bit value 0 (or 1) can represent that there is no UE 104 within the corresponding SN FU's coverage area.

In various arrangements, the various information (e.g., as discussed hereinabove in the example implementation 2) to be reported by the SN 306 to the BS 102 can be carried/transmitted/provided/communicated via at least one of RRC, MAC CE, and/or uplink control information (UCI) signaling, among others. Additionally or alternatively, different parameters can be configured in the same signaling and/or different signalings. For example, the indication can be carried in the uplink control information (UCI) via a transmission in physical uplink control channel (PUCCH) or physical uplink shared channel (PUSCH), and/or medium access control control element (MAC CE) signaling via a transmission in PUSCH, among others.

### Example Implementation 3: BS Controls On/Off Status of SN

In various implementations, the BS 102 can be configured to control the on/off status/state of the SN 306. After the SN 306 finished/completed/performed the measurement operation, the SN 306 can perform one or more other post-measurement operations, such as one or more operations or configurations described in conjunction with the example implementation 2. After the SN 306 performed the other one or more post-measurement operations, the indication of the on/off status can include at least one of the following configurations.

### Example Configuration 1 of Example Implementation 3

In some configurations, the on/off status indication can be explicit, such as explicitly indicated/signaled by the BS 102 the SN 306. The on/off status indication can include/have at least one of the following granularities:
1) Per SN level on/off indication. For example, the BS 102 can indicate or provide the on/off status to a specific SN 306. In this case, the on/off indication can be applicable for one specific SN 306.
2) Group level on/off indication. For example, the BS 102 can indicate an on/off status to one or more SN 306 within a group. In this case, the on/off indication may be applicable for/to one or more SNs 306 within a particular group, or may be applicable for one or more SN FUs controlled by the same SN CU.
3) Beam level on/off indication. For example, the BS 102 can indicate an on/off status applicable for one or more beams of the SN 306. In this case, the beam information and the corresponding on/off status can be indicated (e.g., concurrently or together) to the SN 306. In some cases, the beam information can include or correspond to beam information of the access link and/or beam information of the backhaul link.
4) Link level on/off indication. For example, the BS 102 can indicate an on/off status applicable for one or more/multiple links of the SN 306. In this case, the link information and the corresponding on/off status can be indicated to the SN 306 (e.g., indicated together). In some cases, the link information can include at least one of: forwarding link 1 (e.g., F1), forwarding link 2 (e.g., F2), forwarding link 3 (e.g., F3), and/or forwarding link 4 (e.g., F4).
5) Panel level on/off indication. For example, the BS 102 can indicate an on/off status applicable for one or more panels of the SN 306. In this case, the panel information and the corresponding on/off status can be indicated to the SN 306. In some cases, the panel information can include or correspond to panel information of the access link and/or panel information of the backhaul link.
6) Signal type level on/off indication. For example, the BS 102 can indicate an on/off status applicable for one or more signal types. For instance, the BS 102 may indicate an off status to the SN 306. This off status indication may (only) be applicable for the UE-specific signal forwarding, while the SN 306 can maintain/keep an on status for the common signal forwarding operation.
7) Port level on/off indication. For example, the BS 102 can indicate an on/off status applicable for one or more ports of the SN 306. In this case, the port information and the corresponding on/off status can be indicated to the SN 306. In some cases, the port information can include or correspond to the port information of the access link and/or port information of the backhaul link.
8) Band level on/off indication. For example, the BS 102 can indicate an on/off status applicable for one or more bands of the SN 306. In this case, the band information and the corresponding on/off status can be indicated to the SN 306. In some cases, the band information can include or correspond to one or multiple band information of the access link and/or one or multiple band information of the backhaul link.

Additionally or alternatively, the granularities of the on/off status/state of the SN 306 discussed herein may be applicable or applied to various example configurations (e.g., example configuration 1) of the example implementation 2, for example.

### Example Configuration 2 of Example Implementation 3

In some configurations, the on/off status indication may be implicitly indicated by the BS 102 to the SN 306. In this configuration, at least one of the following can be considered or implemented:
1) If the BS 102 does not have (or is not configured to send) an explicit on/off status indication for/to the SN 306, the SN 306 can maintain/keep an off status until the SN 306 receives/obtains/acquires the side control information from the BS 102. If the SN receives the beam information from the BS 102, the on/off status of the SN 306 can be (e.g., implicitly) determined by, based on, or according to the beam information.
2) If the BS 102 does not have an explicit on/off status indication for the SN 306, the SN 306 may maintain an on status until the SN 306 receives the side control information from the BS 102. If the SN 306 receives the beam information from the BS 102, the on/off status of the SN 306 can be (e.g., implicitly) determined according to the beam information.

In various arrangements, the information (e.g., discussed hereinabove, such as in the example implementation 3) to be indicated by the BS 102 to the SN 306 can be carried/communicated via at least one of RRC, MAC CE, and/or DCI signaling, among others. Additionally or alternatively, the different parameters can be configured in the same signaling and/or different signalings.

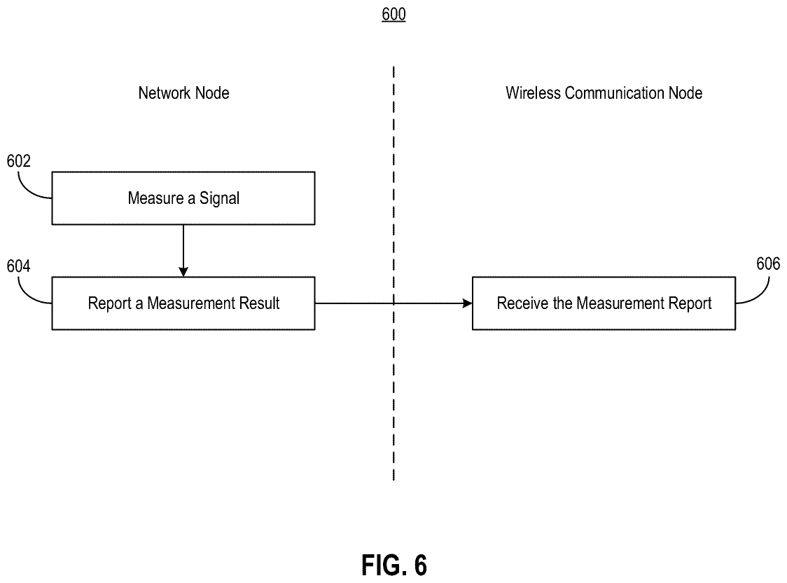

Referring now to FIG. 6, depicted is a flow diagram of an example method 600 for wireless communication device detection, in accordance with an embodiment of the present disclosure. The method 600 may be implemented using any of the components and devices detailed herein in conjunction with FIGS. 1-5. In overview, the method 600 may include measuring a signal (602). The method 600 can include reporting a measurement result (604). The method 600 can include receiving the measurement result (606).

At operation (602), and in some arrangements, a network node (e.g., SN) can measure a signal transmitted/sent/indicated/signaled/communicated/propagated from a wireless communication device (e.g., UE) based on one or more configurations (e.g., measurement configuration, report configuration, and/or resource configuration (used to indicate the signal for measurement and/or signal sent by the wireless communication device) indicated/provided/configured by a wireless communication node (e.g., BS, gNB, or TRP).

In some implementations, the signal transmitted from the wireless communication device can include or correspond to at least one of: a reference signal (RS), a RS with a dedicated port index used for UE (e.g., wireless communication device) detection, a RS with a dedicated RS index used for UE detection, wherein the reference signal comprises at least one of: a sounding reference signal (SRS), a demodulation reference signal (DM-RS), or a phase tracking reference signal (PT-RS), a preamble used for random access, a dedicated preamble used for UE detection (e.g., detect dedicated signal from the wireless communication device to be measured by the network node), a dedicated sequence used for UE detection, a dedicated physical uplink control channel (PUCCH) transmission used for UE detection, a dedicated physical uplink shared channel (PUSCH) transmission used for UE detection, a PUCCH signal, or a PUSCH signal.

In some implementations, the dedicated preamble can be transmitted from the wireless communication device in a dedicated resource. The dedicated resource can include at least one of: a time domain resource, a frequency resource, and/or a dedicated preamble index. In some implementations, the dedicated sequence can include at least one of: an on-off keying (OOK) sequence, a Zadoff-Chu (ZC) sequence, a pseudo-random sequence, a computer-generated sequence (CGS), and/or a low peak-to-average-power ratio (PAPR) sequence.

In some implementations, when the signal is the preamble used for the random access, transmitted from the wireless communication device, the network node can measure the preamble during a random access channel (RACH) occasion. In some implementations, the one or more configurations may be indicated/provided/signaled to the network node via at least one of: a system information (SI) signal, a radio resource control (RRC) signal, a downlink control information (DCI) signal, and/or a medium access control element (MAC CE) signal.

In some implementations, the one or more configurations can include/comprise at least one of: one or more signal configurations, one or more report configurations associated with one or more signal configurations, and/or one or more measurement filtering coefficients used to process the measurement results. In some implementations, each signal configuration (e.g., common resource configuration) can include at least one of: a signal index, where the signal index can be used to specify a signal to be measured by the network node and sent from the wireless communication device, where the signal index can include at least one of: reference signal (RS) index, logic index, and/or preamble index; information used to generate and initialize a sequence or an RS sequence; and/or information indicating a resource (e.g., time and/or frequency resource occupied by the signal, such as RACH occasion, etc.) for the signal comprising at least one of: Random Access channel (RACH) occasion, frequency resource information, time resource information, bandwidth part (BWP) identity, subcarrier space (SCS), cell index or cell identity (ID), port information used to measure the signal, and/or one or more beam information used to measure the signal. The one or more beam information can include at least one of beam information for an access link and/or beam information for a backhaul link. The access link can include a first access link from the network node to the wireless communication device and/or a second access link from the wireless communication device to the network node. The backhaul link can include a first backhaul link from the wireless communication node to the network node and/or a second backhaul link from the network node to the wireless communication node.

In some implementations, the frequency resource information can include at least one of a start Physical Resource Block (PRB), a start resource element (RE), an end PRB, an end RE, an RB offset or an RE offset, a number of PRBs or a number of REs, a frequency shift, a frequency offset, an Absolute Radio Frequency Channel Number (ARFCN), and/or a Global Synchronization Raster (GSCN). In some implementations, the time resource information can include at least one of: a periodicity, a slot offset, a start slot, a start symbol, a number of slots, a number of symbols, a start and length indicator value (SLIV), a pattern, a time domain resource allocation (TDRA) index, and/or a duty cycle.

In some implementations, the one or more beam information for the one or more signal configurations can be the same or different. In some implementations, each report configuration can include at least one of: a measurement report index, where the measurement report index can be used to specify a report configuration, and where the measurement report index can be a logic index, a report type, where the report type can include at least one of: an event-triggered report and/or a periodic report, an indication on whether to include beam level measurement results in a report, where the beam level measurement results may be the results measured by the network node using a beam information, a maximum number of beam level measurement result value or the number of beam level measurement result value included in the report for each measured signal, and/or one or more measurement filtering coefficients used to process measurement results.

In some implementations, when the report type is the event-triggered report, the one or more report configurations can include at least one of: at least one event identity (ID) used to specify an event for measurement by the network node, a maximum number of measured signals to be included in the report, a number of reports, report quantity comprising at least one of: reference signal received power (RSRP), received signal strength indicator (RSSI), reference signal received quality (RSRQ), or signal-to-interference noise ratio (SINR), a report interval indicative of an interval between reports, a threshold value used for the network node to determine whether to trigger the event-triggered report, a time when one or more criteria for an event are to be satisfied to trigger the event-triggered report, an indication to indicate whether the network node shall initiate a report procedure when a leaving condition is satisfied for a measured signal, and/or a parameter used for at least one of an entry condition or a leave condition of an event-triggered report condition.

In some implementations, when the report type is the periodic report, the one or more report configurations can include at least one of: a maximum number of measured signals to be reported in the report, a number of reports, a report quantity comprising at least one of: reference signal received power (RSRP), received signal strength indicator (RSSI), reference signal received quality (RSRQ), or signal-to-interference noise ratio (SINR), a report interval indicative of an interval between periodic reports, a threshold value used for the network node to determine whether to trigger the periodic report.

In some implementations, an association between the one or more signal configurations and one or more report configurations can include at least one of: each signal configuration is associated with one or more report configurations, and/or each report configuration is associated with one or more signal configurations.

In some implementations, the network node may determine, responsive to measuring the signal, an on/off state of the network node according to measured results of the signal. The determining/determination can be performed according to at least one of the following conditions: the network node may compare the measured results of the signal with one or more thresholds; a number of detected signals; the network node may compare the number of detected signals with one or more specific values; and/or whether the signal is detected.

In some implementations, at least one of: the one or more specific values for different signals may be the same or different; the one or more specific values can be predefined for the network node via an operations, administration, and maintenance (OAM); and/or the one or more specific values can be configured to the network node from the wireless communication node via at least one of a radio resource control (RRC) signal, a downlink control information (DCI) signal, and/or a medium access control element (MAC CE) signal. In some implementations, the network node may send an indication indicating the on/off state of the network node to the wireless communication node.

At operation (604), and in some arrangements, the network node may report/indicate, responsive to measuring the signal, a measurement result performed based on the one or more configurations to the wireless communication node. At operation (606), and in some arrangements, the wireless communication node can receive the measurement result reported by/from the network node.

In some implementations, the measurement result can include at least one of: signal index; signal strength including at least one of reference signal received power (RSRP), received signal strength indicator (RSSI), reference signal received quality (RSRQ), signal-to-interference noise ratio (SINR), and/or signal-to-interference ratio (SIR); the signal strength that is an average (e.g., mean or median) strength determined based on a plurality of beam level signal strengths, where the plurality of beam level signal strengths can be measured by the network node using a specific beam; one or more beam level signal strengths or one or more associated beam information; a strongest beam level signal strength value of a plurality of beam level measured result values or associated beam information; and/or an N strongest beam level measurement result values or a corresponding N beam information, where N can represent/indicate a number of reported beam level signal strengths, determined via at least one of: the N is configured to the network node and/or the wireless communication node via operations, administration, and maintenance (OAM), the N can be configured from the wireless communication node to the network node via at least one of a radio resource control (RRC) signaling, a downlink control information (DCI) signaling, and/or a medium access control element (MAC CE) signaling; an integer value determined according to a comparison between the signal strength and one or more thresholds; and/or one or more integer values determined according to a comparison between a beam level signal strength and one or more thresholds and one or more associated beam information.

In some implementations, the signal strength can be obtained after processing by Layer 1 filtering and/or Layer 3 filtering. In some implementations, at least one of: the one or more thresholds can be provided to the network node from the wireless communication node via at least one of: the RRC signaling, the MAC CE signaling, and/or the DCI signaling, the one or more thresholds may be provided to the network node via the OAM, and/or the one or more thresholds can be determined based on a capability of the network node and reported from the network node to the wireless communication node.

In some implementations, the network node can send an indication to the wireless communication node to indicate whether there is at least one wireless communication device under a serving area of the network node according to a measurement result of the network node, for example. In some implementations, the measurement result or the indication can be transmitted via at least one of: uplink control information (UCI) via a transmission in physical uplink control channel (PUCCH) or physical uplink shared channel (PUSCH), and/or medium access control control element (MAC CE) signaling via a transmission in PUSCH.

In some implementations, the network node can receive/obtain/acquire an explicit indication from the wireless communication node indicating an on/off state of the network node. In some implementations, a granularity of an on/off state indication can include at least one of: the on/off state indication used for one or more network nodes, the on/off state indication used for one or more beams of the network node, where the one or more beams of the network node can include at least one of: beams for at least one access link, and/or beams of at least one backhaul link, the on/off state indication used for at least one of a plurality of links of the network node, where the plurality of links can include at least one of a first backhaul link, a second backhaul link, a first access link, a second access link, a first control link from the wireless communication node to the network node, and/or a second control link from the network node to the wireless communication node, the on/off state indication used for one or more panels of the network node, the on/off state indication used for one or more ports of the network node, the on/off state indication used for one or more bands of the network node, and/or the on/off state indication used for one or more signal types of the network node.

In some implementations, the indication can be sent through/via at least one of: a radio resource control (RRC) signaling, a downlink control information (DCI) signaling, and/or a medium access control element (MAC CE) signaling. In some implementations, when the network node detects/identifies that an explicit on/off indication is not received (e.g., absent) from the wireless communication node, the network node may determine (or trigger) an on state of the network node until the network node receives control information from the wireless communication node used to control a forwarding operation of the network node.

In some implementations, when the network node detects that an explicit on/off indication is not received from the wireless communication node, the network node can determine an off state of the network node until the network node receives beam information from the wireless communication node used to control a forwarding operation of the network node. In some implementations, when the network node receives beam information from the wireless communication node to control a forwarding operation of the network node, an on/off state of the network node may be implicitly indicated according to the received beam information.

While various embodiments of the present solution have been described above, it should be understood that they have been presented by way of example only, and not by way of limitation. Likewise, the various diagrams may depict an example architecture or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, which may be referenced in the above description, can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
measuring, by a network node, a signal transmitted from a wireless communication device based on one or more configurations indicated by a wireless communication node.

2. The wireless communication method of claim 1, wherein the signal transmitted from the wireless communication device includes at least one of:
a reference signal (RS),
a RS with a dedicated port index used for UE detection,
a RS with a dedicated RS index used for UE detection, wherein the reference signal comprises at least one of: a sounding reference signal (SRS), a demodulation reference signal (DM-RS), or a phase tracking reference signal (PT-RS),
a preamble used for random access,
a dedicated preamble used for UE detection,
a dedicated sequence used for UE detection,
a dedicated physical uplink control channel (PUCCH) transmission used for UE detection,
a dedicated physical uplink shared channel (PUSCH) transmission used for UE detection,
a PUCCH signal, or
a PUSCH signal.

3. The wireless communication method of claim 2, wherein the dedicated preamble is transmitted from the wireless communication device in a dedicated resource, wherein the dedicated resource includes at least one of: a time domain resource, a frequency resource, or a dedicated preamble index.

4. The wireless communication method of claim 2, wherein the dedicated sequence includes at least one of: an on-off keying (OOK) sequence, a Zadoff-Chu (ZC) sequence, a pseudo-random sequence, a computer-generated sequence (CGS), or a low peak-to-average-power ratio (PAPR) sequence.

5. The wireless communication method of claim 2, wherein when the signal is the preamble used for the random access, transmitted from the wireless communication device, the network node measures the preamble during a random access channel (RACH) occasion.

6. The wireless communication method of claim 1, wherein the one or more configurations are indicated to the network node via at least one of: a system information (SI) signal, a radio resource control (RRC) signal, a downlink control information (DCI) signal, or a medium access control element (MAC CE) signal.

7. The wireless communication method of claim 1, wherein the one or more configurations comprise at least one of:
one or more signal configurations,
one or more report configurations associated with one or more signal configurations, or
one or more measurement filtering coefficients used to process the measurement results.

8. The wireless communication method of claim 7, wherein each signal configuration comprises at least one of:
a signal index, wherein the signal index is used to specify a signal to be measured by the network node and sent from the wireless communication device, wherein the signal index includes at least one of: reference signal (RS) index, logic index, or preamble index;
information used to generate and initialize a sequence or an RS sequence; or
information indicating a resource for the signal comprising at least one of:
Random Access channel (RACH) occasion,
frequency resource information,
time resource information,
bandwidth part (BWP) identity,
subcarrier space (SCS),
cell index or cell identity (ID),
port information used to measure the signal, or
one or more beam information used to measure the signal, wherein the one or more beam information comprises at least one of beam information for an access link or beam information for a backhaul link, wherein the access link includes a first access link from the network node to the wireless communication device and a second access link from the wireless communication device to the network node, and wherein the backhaul link includes a first backhaul link from the wireless communication node to the network node and a second backhaul link from the network node to the wireless communication node.

9. The wireless communication method of claim 8, wherein the frequency resource information comprises at least one of a start Physical Resource Block (PRB), a start resource element (RE), an end PRB, an end RE, an RB offset or an RE offset, a number of PRBs or a number of REs, a frequency shift, a frequency offset, an Absolute Radio Frequency Channel Number (ARFCN), or a Global Synchronization Raster (GSCN).

10. The wireless communication method of claim 8, wherein the time resource information comprises at least one of: a periodicity, a slot offset, a start slot, a start symbol, a number of slots, a number of symbols, a start and length indicator value (SLIV), a pattern, a time domain resource allocation (TDRA) index, or a duty cycle.

11. The wireless communication method of claim 8, wherein the one or more beam information for the one or more signal configurations is same or different.

12. The wireless communication method of claim 7, wherein each report configuration comprises at least one of:
a measurement report index, wherein the measurement report index is used to specify a report configuration, and wherein the measurement report index is a logic index,
a report type, wherein the report type includes at least one of: an event-triggered report or a periodic report,
an indication on whether to include beam level measurement results in a report, wherein the beam level measurement results are the results measured by the network node using a beam information,
a maximum number of beam level measurement result value or the number of beam level measurement result value included in the report for each measured signal, or
one or more measurement filtering coefficients used to process measurement results.

13. The wireless communication method of claim 12, wherein when the report type is the event-triggered report, the one or more report configurations comprise at least one of:
event identity (ID) used to specify an event for measurement by the network node,
a maximum number of measured signals to be included in the report,
a number of reports,
report quantity comprising at least one of: reference signal received power (RSRP), received signal strength indicator (RSSI), reference signal received quality (RSRQ), or signal-to-interference noise ratio (SINR),
a report interval indicative of an interval between reports,
a threshold value used for the network node to determine whether to trigger the event-triggered report,
a time when one or more criteria for an event are to be satisfied to trigger the event-triggered report,
an indication to indicate whether the network node shall initiate a report procedure when a leaving condition is satisfied for a measured signal, or
a parameter used for at least one of an entry condition or a leave condition of an event-triggered report condition.

14. The wireless communication method of claim 12, wherein when the report type is the periodic report, the one or more report configurations comprise at least one of:
a maximum number of measured signals to be reported in the report,
a number of reports,
a report quantity comprising at least one of: reference signal received power (RSRP), received signal strength indicator (RSSI), reference signal received quality (RSRQ), or signal-to-interference noise ratio (SINR),
a report interval indicative of an interval between periodic reports,
a threshold value used for the network node to determine whether to trigger the periodic report.

15. The wireless communication method of claim 7, wherein an association between the one or more signal configurations and one or more report configurations includes at least one of:
each signal configuration is associated with one or more report configurations, or
each report configuration is associated with one or more signal configurations.

16. The wireless communication method of claim 1, further comprising:
determining, by the network node, responsive to measuring the signal, an on/off state of the network node according to measured results of the signal.

17. The wireless communication method of claim 16, wherein the determining is performed according to at least one of following:
comparing, by the network node, the measured results of the signal with one or more thresholds;
a number of detected signals;
comparing, by the network node, the number of detected signals with one or more specific values; or
whether the signal is detected.

18. The wireless communication method of claim 17, wherein at least one of:
the one or more specific values for different signals are same or different;
the one or more specific values are predefined for the network node via an operations, administration, and maintenance (OAM); or
the one or more specific values are configured to the network node from the wireless communication node via at least one of a radio resource control (RRC) signal, a downlink control information (DCI) signal, or a medium access control element (MAC CE) signal.

19. The wireless communication method of claim 16, further comprising:
sending, by the network node to the wireless communication node, an indication indicating the on/off state of the network node.

20. A network node, comprising:
at least one processor configured to:
measure a signal transmitted from a wireless communication device based on one or more configurations indicated by a wireless communication node.
